(19) United States
(12) Patent Application Publication
(10) Pub. No.: US 2011/0229789 A1
(43) Pub. Date: Sep. 22, 2011

(54) SOFC STACK WITH CORRUGATED SEPARATOR PLATE

(75) Inventors: Nicolaas Jacobus Joseph Dekker, Amsterdam (NL); Arnoldus Hermannus Henderikus Janssen, Heerhugowaard (NL)

(73) Assignee: STICHTING ENERGIEONDERZOEK CENTRUM NEDERLAND, Petten (NL)

(21) Appl. No.: 13/124,935

(22) PCT Filed: Oct. 20, 2009
(86) PCT No.: PCT/NL2009/050631

§ 371 Date: Jun. 7, 2011

(30) Foreign Application Priority Data
Oct. 20, 2008 (NL) 2002113

(51) Int. Cl. H01M 8/04; H01M 8/10; H01M 8/24

(52) U.S. Cl. 429/457; 429/488

(57) ABSTRACT

SOFC cell unit in which a separator plate provided with a corrugation is fitted and bears directly against the anode and cathode, respectively. Anode gas and cathode gas preferably move in the same direction and anode gas is supplied from a number of anode gas supply openings extending through a cell stack. These openings are situated on the side parallel to the direction of the ducts formed by the corrugation. Cathode gas can be fed directly into the corrugation. In this way, it is possible to produce a highly efficient cell and an associated compact cell stack in a simple manner.

The present invention relates to an SOFC cell unit cell stack respectively according to the preamble of Claim 1. Such a structure is, for example, known from patent NL1026861 or WO 2004/049483 A2.

Although such a cell unit has advantages compared with what is known from the other prior art, there are limitations with regard to the capacity of such stacks.

It is an object of the present invention to increase the capacity of cell stacks and to simplify the cell stack.

Starting from proper cell consisting of anode, electrolyte and cathode comprising, on the anode side, a structure consisting of two slot plates is used therein to provide gas ducts for the anode gas when placing said slots on top of one another in a staggered manner.

With this known structure, a grid structure is used on the cathode side which consists of two plates comprising a current collector and a gas-distribution element (expanded metal). In addition, use is made of an auxiliary plate in which slots are provided for laterally supplying cathode gases and openings for the vertical flow of anode gases.

Although this cell unit is satisfactory in principle, it has a number of drawbacks. First, the number of components is relatively large. Apart from resulting in an increase in the production costs, it also creates problems in respect of sealing, since each component has a tolerance and, if a number of components are stacked on top of one another, the total tolerance may become such that sealing is no longer simple.

It is an object of the present invention to provide a simplified cell unit by means of which it is possible to achieve an exceptionally high efficiency under conditions which can be controlled very well. In addition, it is an object of the invention to improve the number of electrical junctions and thus to improve the resistance of the cell stack. It is also intended to achieve improved gas distribution, in particular improved distribution of the anode gas and cathode gas. In addition, it is intended to produce a sealing which is of a simpler embodiment, thus reducing the risk of leaks, in particular in a cell stack.

This object is achieved by a cell unit having the features of Claim 1.

By means of the present invention, it is possible to arrange the anode and cathode opening in a perpendicular position with respect to one another, as a result of which the cross section of the opening for each of these openings can be made so large that this results in as small a flow resistance as possible, and an even distribution of gases is possible. Preferably, the flow of anode and cathode gas takes place in the same direction (co-flow), as a result of which the action of the cell is optimized. In addition, it is possible in this way to simplify the embodiment of the various sealings as much as possible and to limit the number of sealings and the length thereof, thus increasing the operational reliability.

According to the present invention, it is proposed as a first step to no longer embody the separator plates known from the prior art as flat, but to provide them with an undulation or corrugation. The space between the corrugations functions as a duct for either the anode gas or cathode gas. According to the present invention, this corrugation is realised in such a manner that it can bear directly against the anode or cathode. As a result thereof, a number of parts of the existing concept become redundant, i.e. the above-described two slot plates on the anode side and the expanded metal on the cathode side. This results in a much more compact cell unit which can be sealed more simply because the tolerances which the sealing has to accommodate are smaller. In addition, there are fewer electrical junctions, resulting in a higher performance of the cell unit.

In addition, by moving the anode gas supply duct to the side of the cell, the anode and cathode gas distribution across the cell is improved.

In this particular embodiment, anode gas and cathode gas (and the discharge thereof, respectively) are supplied to different sides of the substantially rectangular cell, but the flow follows this corrugation. More particularly, this displacement takes place in co-flow so that an optimum efficiency of the cell can be achieved. This means that the temperature distribution is optimized as well as the degree of depletion (uniform) of the (anode) gas used. As a result thereof, a high degree of conversion and thus a high efficiency can be achieved. The supply of cathode gas can (with small cell stacks) take place both via openings which are arranged in the separator plates and situated on top of one another and (with large cell stacks) by means of a supply/discharge situated outside the cell unit. In the latter case (with external manifolding), a particularly large amount of cathode gas can be passed across the cell, as a result of which the cathode gas not only has an electrochemical function, but also a cooling function. Cathode gas can be supplied in excess. The above-described cell may both be anode-supported and electrolyte-supported.

According to a particular embodiment of the present invention, the corrugation of the anode and/or cathode inlet duct and/or outlet duct extends and supports a sealing thereon. That is to say, the corrugation provides a large number of parallel ducts while, on the other hand, the packing is supported by the corrugation. If the cell stack is relatively large, this will result in problems with the sealing. It has been found that this is caused by the fact that the pressure on the respective packings is insufficient. This is caused by the fact that a packing does indeed work between two (sheet-metal) parts, but that a cavity which is defined by the structure is present under one of those parts for the supply and/or discharge of a gas. As a result thereof, the series of packings which are stacked one behind the other do not form a rigid unit as there is always an opening present and it is not possible to produce a sufficiently large packing pressure to provide a sealing without closing off the respective opening and/or ducts, as in WO 2004/049483A. By contrast, according to the invention, each packing is supported in the direction of stacking by an underlying packing, as a result of which a sufficiently large packing pressure is achieved to ensure satisfactory sealing.

According to a further embodiment of the present invention, a current collector is avoided by arranging the cathode such that it bears directly against the separator plate. In this case, the plate in which the cell is accommodated (cathode gas supply plate) is preferably embodied as a flat plate, that is to say not provided with ducts. In this embodiment, the ducts which provide the connection between the cathode and the cathode inlet and/or outlet are arranged in the separator plate which, to this end, is provided with additional corrugation and is preferably produced by pressing. In addition, according to a further advantageous embodiment, the separator plate is provided with additional elevations for taking over the role of current collector.

The invention also relates to an SOFC cell stack in which a number of cell units are stacked on top of one another as described above and which comprise common separator plates.

The invention will be described below with reference to an exemplary embodiment which is illustrated in the drawing, in which:

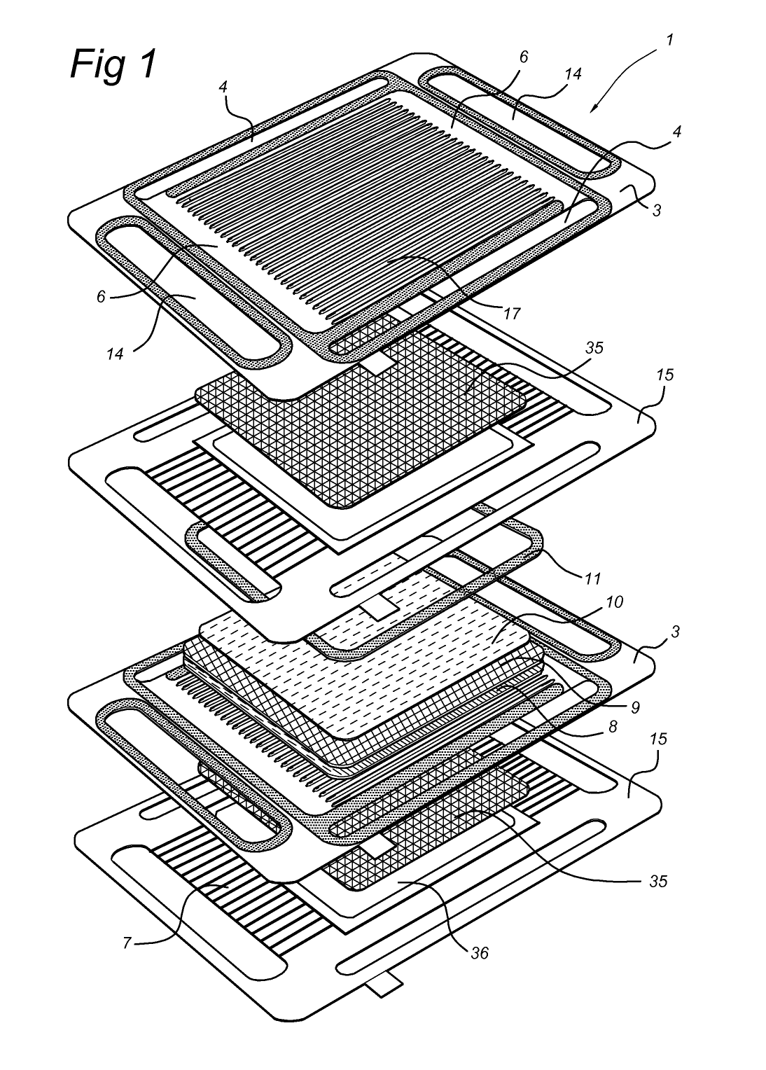

FIG. 1 diagrammatically shows the various parts for forming a cell unit;

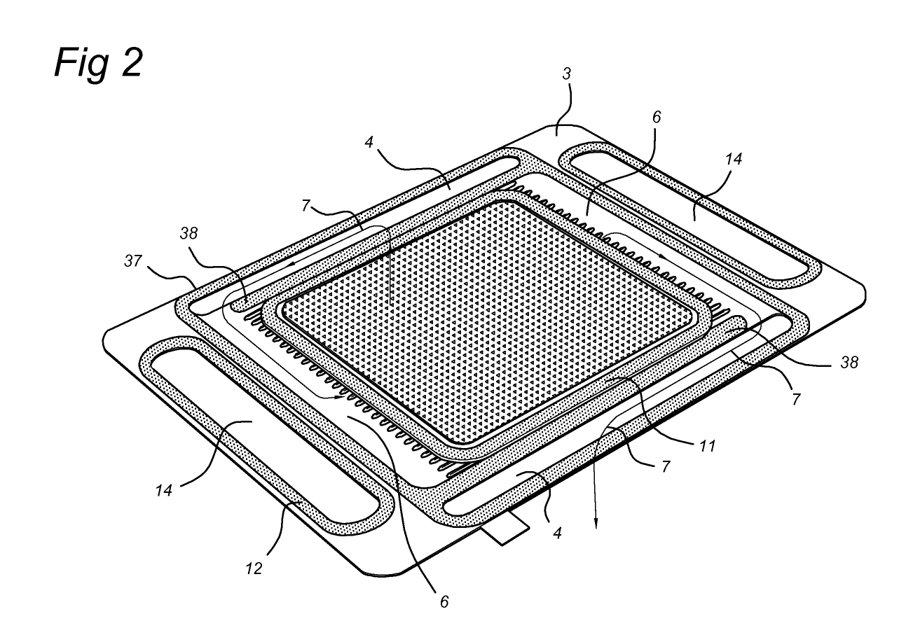

FIG. 2 shows a separator plate with cell and sealings in more detail;

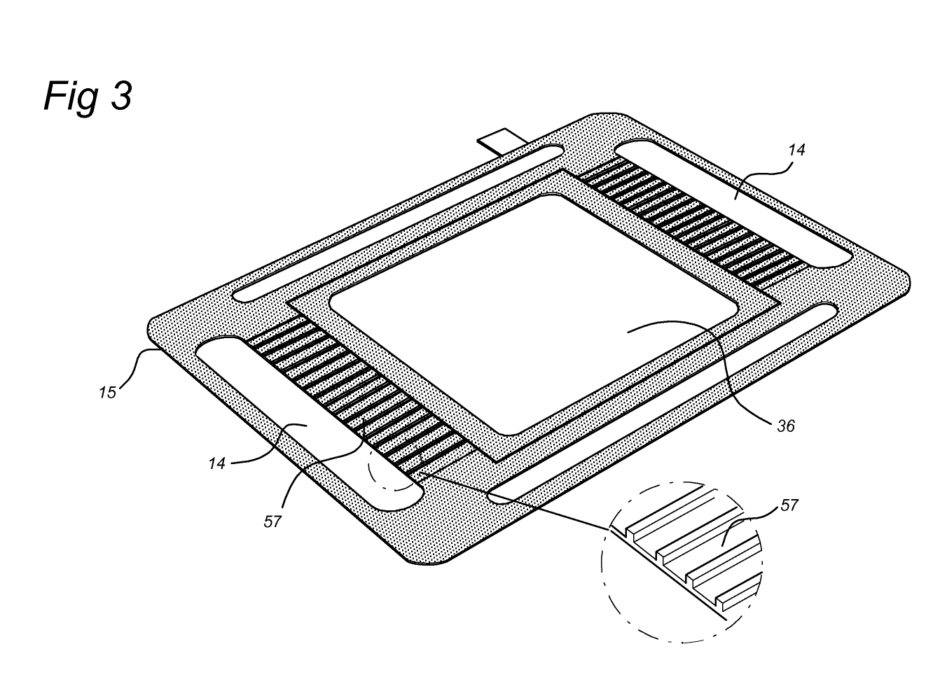

FIG. 3 shows a top view of the cathode gas supply plate in detail;

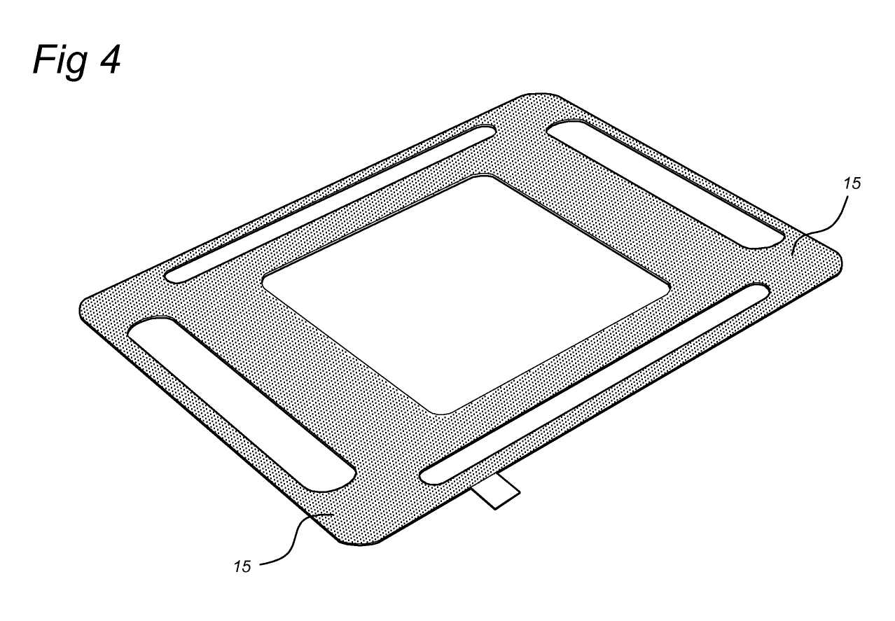

FIG. 4 shows a bottom view of the cathode gas supply plate;

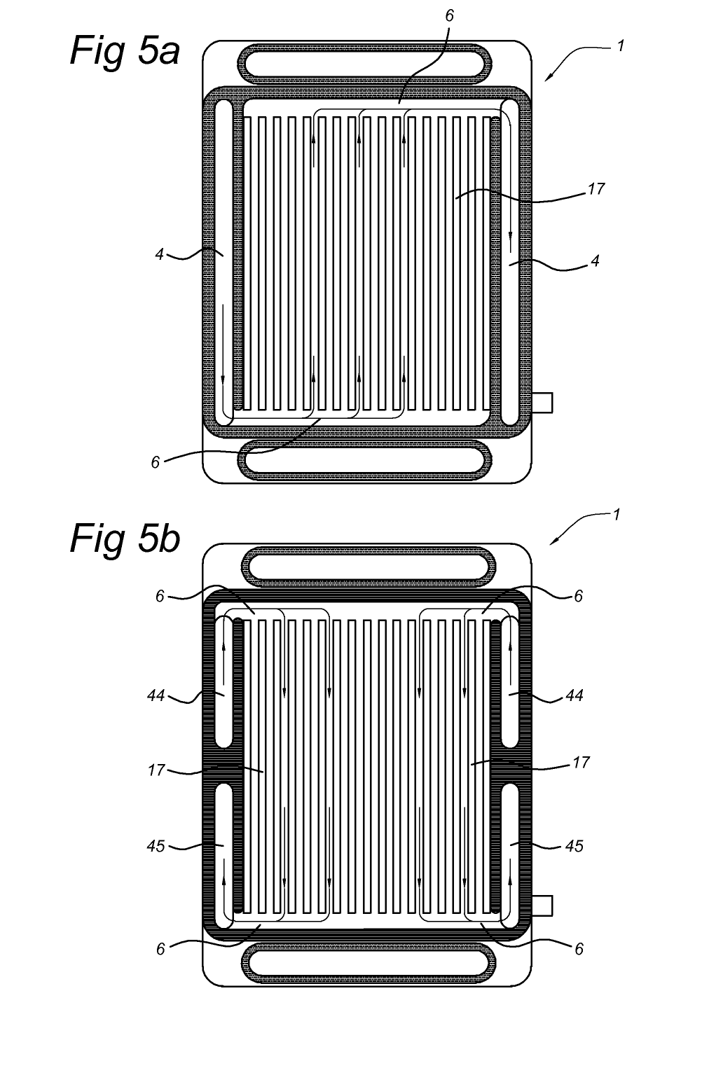

FIG. 5 shows a variant of the structure shown in the previous figures;

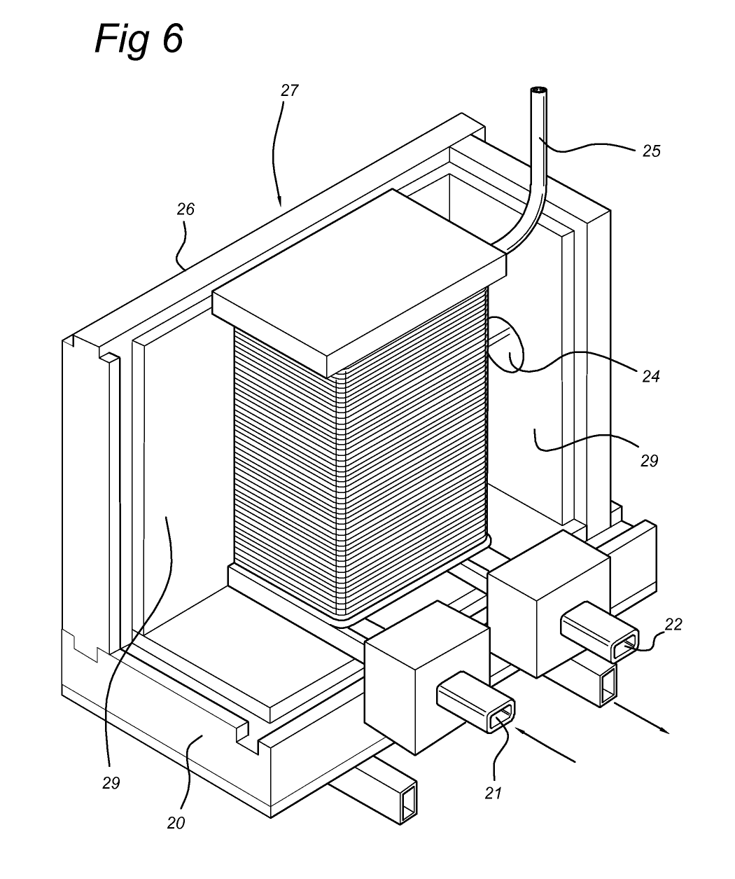

FIG. 6 shows a particular embodiment of the variant shown in FIG. 5,

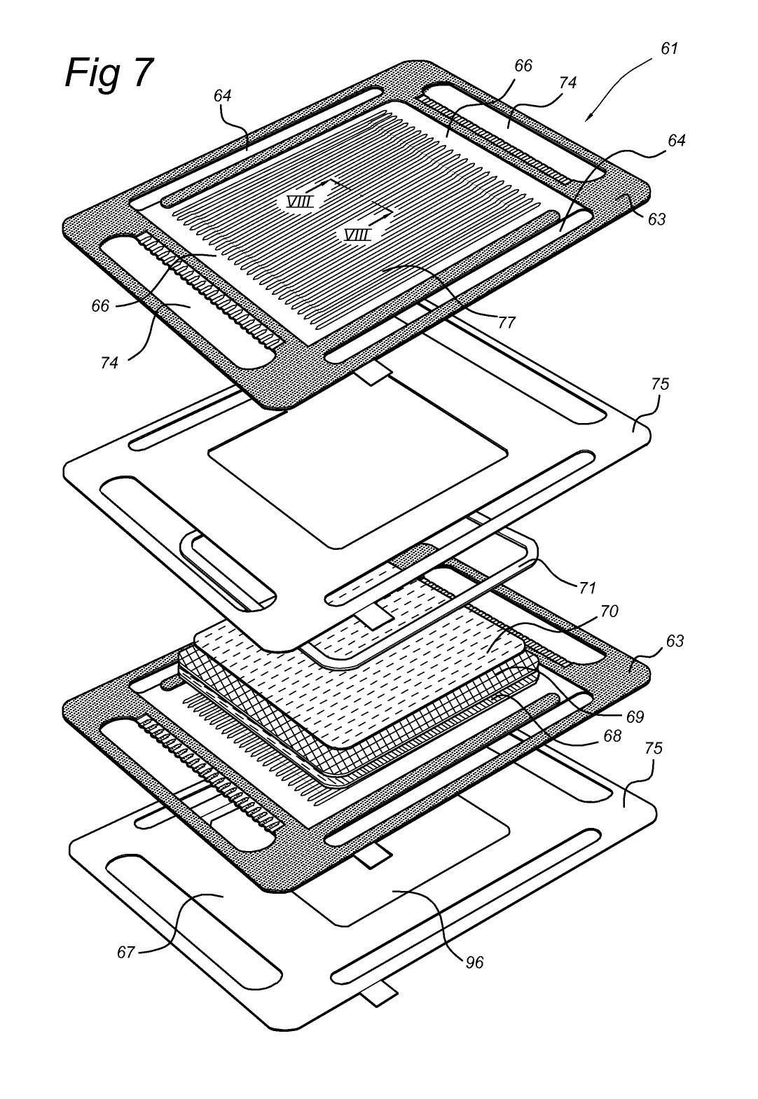

FIG. 7 shows a further variant of the structure shown in FIG. 1,

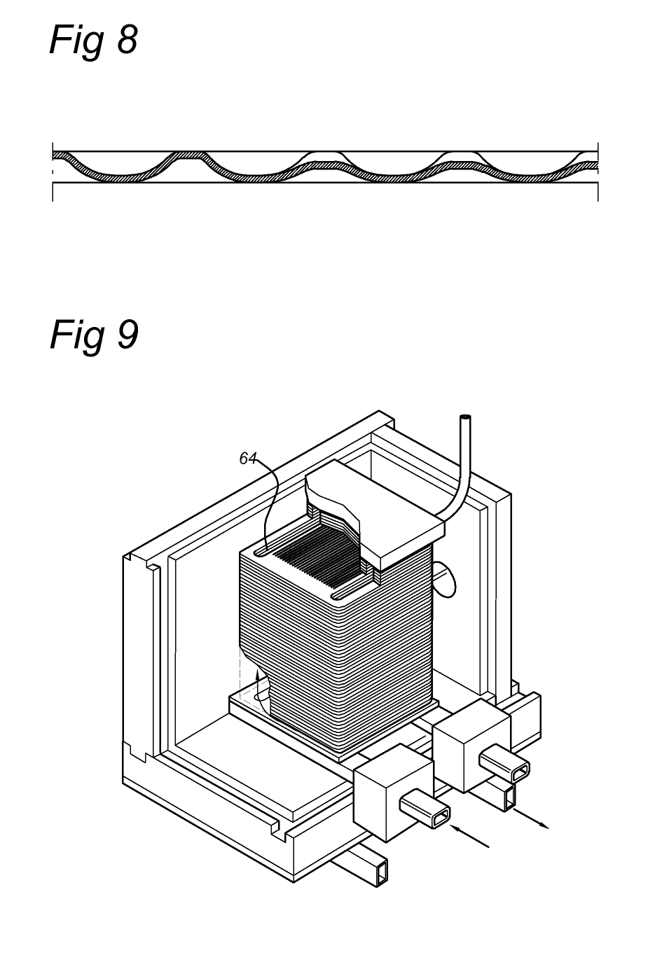

FIG. 8 shows a detail from FIG. 7 and

FIG. 9 shows a further variant from FIG. 6.

In FIG. 1, a cell unit is denoted overall by reference numeral 1. As is clear from FIG. 6, the latter is preferably combined with a large number of other cell units in order to thus form a cell stack.

The actual cell is formed by electrolyte 9 which is delimited on one side by anode 8 and delimited on the other side by cathode 10. According to the invention, separator plates 3 are present on either side of the actual cell unit, with the topmost separator plate 3 directly adjoining the cathode 10 and the bottommost separator plate 3 directly adjoining the anode 8. This means that there are no further components between the separator plate and the anode and cathode, respectively. If desired, a current collector plate 35 is present between the cathode 10 and the respective separator plate 3. The surface of the cathode 10 and more particularly the outer circumference thereof is smaller than that of the electrolyte 9 and/or anode 8. As a result thereof, a packing 11 can be arranged on the electrolyte 9, with the cathode 10 being enclosed thereby. If a current collector plate 35 is present, the latter is also enclosed by the sealing 11. This sealing 11 provides a gas sealing between the anode gas and the cathode gas.

In order to enable gas and electrons to be transported, the separator plate 3 according to the invention is designed in a particular way. In the embodiment shown in FIGS. 1-4, the latter consists of a plate which is flat along the periphery and has a corrugation 17 in the centre thereof. The surface of the corrugation 17 corresponds to the surface of the anode. Because the surface of the cathode is smaller than that of the anode and the corrugation extends on both sides of the separator plate 3, the surface of the corrugation will be larger than that of the cathode. On the periphery of separator plate 3, there are anode gas supply/discharge openings 4 and at right angles thereto, i.e. in the direction in line with the corrugations 17, cathode gas supply/discharge openings 14. A cathode gas supply plate 15 is placed between two separator plates. It is provided with an internal opening 36 to enable a current collector 35 to be accommodated therein.

As can be seen in the top view from FIG. 3, it is provided with cathode gas ducts 57 on one side while, as can be seen in FIG. 4, the bottom side of this cathode gas supply plate 15 is of a flat design. As can be seen in FIGS. 1 and 2, a number of sealings are present. Annular sealings 12 seal the cathode gas ducts 14. A further sealing 37 is present in order to seal the anode gas ducts 4. However, in order to make a flow of anode gas possible, an inner portion of this sealing, denoted by reference numeral 38, is designed to end in an unattached manner. Anode gas is transported in accordance with the arrows 7.

Due to the presence of a number of spaced-apart cathode gas ducts 57 and the webs situated in between, packing pressure which is transmitted from the ends to a cell stack is transferred to the next component of the cell stack via these webs which are situated between the ducts 57. As a result thereof, it is possible to ensure that there is in each case sufficient packing pressure on every packing and thus sealing across a relatively large cell stack.

A manifold 6 in each case adjoins the openings 4. This means that the anode gas is moved at right angles to the direction in which it is supplied by the above-described corrugations 57 along the anode side of the cell. As the separator plate 3 preferably is a metallic plate into which the corrugations are pressed, the corrugations substantially have the same position and the same direction (for example longitudinal direction) on both sides of the plate. It is possible to make the cross-sectional dimension of the cathode gas ducts slightly larger (for example 10-50% larger) than the cross-sectional dimension of the anode gas ducts by influencing the shape of the corrugation. This is due to the fact that the cathode gas can also have the function of a coolant gas in addition to its electrochemical function.

The cathode gas can move in the same direction as the anode gas. The used sealing material may be any material known from the prior art. According to an exemplary embodiment of the invention, a glass material, and more particularly a glass/ceramic material, is used for this purpose. If desired, combinations with mica are possible.

FIG. 5 diagrammatically shows a number of possibilities for the anode gas stream.

FIG. 5a shows the embodiment illustrated in FIGS. 1-4 in which the anode gas flows across the entire width of the separator plate, distributed via a single manifold 6 through the corrugations 17 via a single opening 4, to a manifold 6 opposite and is discharged again via the associated opening 4.

FIG. 5b shows a variant in which the duct 4 is split into two ducts 44 and 45 with duct 44 being a supply duct and duct 45 being a discharge duct. In this embodiment, the gas is supplied and discharged symmetrically via manifold 6, as a result of which the uniform distribution of the anode gas across the cell may be improved.

With relatively large cell stacks, it is possible to perform the supply of cathode gas via an external manifold. In the case of such an embodiment, the cathode gas openings 14 shown in the previous figures are no longer incorporated in the separator plate 3. This means, for example with the embodiment as illustrated in FIG. 1, that the outer boundary of the separator plate is formed by the outer boundary of the sealing 37. As a result thereof, a particularly compact cell unit can be produced, in which the cathode gas is supplied via an external manifold. Such a variant can also be used with the flow illustrated in FIG. 5b. This is shown by way of example in FIG. 6. In this case, a sealing is present on the anode side between the bottommost cell unit and the anode gas supply opening 21 and the anode gas discharge opening 22. On the cathode side, the corrugations are open to the environment via ducts 57 (see FIG. 1).

A large number of cell units is stacked on top of one another and forms a cell stack 27. The cathode gases are supplied by means of a closed cabinet 26. The cell stack 27 divides this cabinet into a cathode gas supply distribution space 29 and a cathode gas discharge distribution space 29 with the latter space being provided with a discharge opening 24. Anode gas is supplied via opening 21 and discharged via opening 22. These openings end in openings 4 as described above. The embodiment from FIG. 6 has the advantage that large amounts of cathode gas (air) can be fed through in a simple manner, so that this can have a cooling function.

FIG. 7 shows a further variant of the present invention. In as far as applicable, the reference numerals used in the latter correspond to those used in FIG. 1 except that they have been increased by 60. This means that the cell unit is denoted overall by reference numeral 61, with the actual cell being formed by electrolyte 69 which is delimited on one side by an anode 68 and on the other side by a cathode 70. In this variant, plates 63 and 75 are embodied differently. Here, plate 75 is a smooth plate, that is to say that the ducts illustrated in FIG. 3 are not present therein. Neither is there a current collector present in this embodiment.

In order to enable gas to be transported, plate 63 is provided with a ribbing or corrugation 77. On the top side illustrated, the latter is sealed by the packings and on the bottom side this function is performed by the ducts 57 which have been illustrated in FIG. 3. In addition, the corrugation 77 is provided with a local elevation at the location of the cathode, as can be seen in the illustrated detail from FIG. 8, as a result of which no separate current collector is required.

FIG. 9 shows a cell stack with external manifolding, in which a part is broken away at the top side to show that, compared to FIG. 7, ducts 64 are present and ducts 74 are not.

Upon reading the above, those skilled in the art will immediately be able to think of variants which fall within the scope of the attached claims and are obvious following reading of the above.

1-11. (canceled)

12. SOFC cell unit which is of substantially rectangular design, comprising an anode, an electrolyte and a cathode, gas-distribution means for the anode and cathode gases, said gas stream distribution means comprising a corrugated part in the central section thereof, the ducts of said corrugation serving to transport anode and cathode gas, respectively, wherein said corrugation bearing directly against either the anode or the cathode, wherein the separator plate comprises an anode inlet opening and an anode outlet opening at the opposite side, with an anode inlet duct being connected to the anode inlet opening and an anode outlet duct being connected to the anode outlet opening, formed by the openings in and sealings on the separator plate, wherein the anode gas supply/discharge and cathode gas supply/discharge are provided on different sides of said unit and separator plate, respectively, wherein the anode inlet and cathode inlet are arranged in such a manner that a co-flow of anode and cathode gases is achieved.

13. Cell unit according to claim 12, wherein both the anode and the cathode bear directly against the corrugation.

14. Cell unit according to claim 13, wherein a current collector is arranged between the cathode and the corrugation.

15. Cell unit according to claim 12, wherein the cathode inlet and cathode outlet comprise a part which is separate from the cell unit.

16. Cell unit according to claim 12, wherein said corrugation comprises an undulating pattern which extends from the centre plane of the separator plate to both sides of said separator plate, with the cross-sectional dimension of the ducts delimited by the corrugation being at least 10% larger for the cathode gas ducts than for the cross-sectional dimension of the anode gas ducts.

17. Cell unit according to claim 16, in which said corrugation comprises a deformation.

18. Cell unit according to claim 12, comprising a gas supply plate arranged between two separator plates and accommodating the anode, electrolyte and the cathode therein.

19. Cell unit according to claim 12, wherein the gas supply ducts for the cathode are arranged in the separator plate and the gas stream distribution means comprise a flat part on the periphery of the cell unit on which a packing lies.

20. Cell unit according to claim 12, wherein the cathode bears directly against the separator plate and the separator plate is provided with a corrugation near the anode and cathode inlet duct and outlet duct, respectively.

21. Cell unit according to claim 12, comprising a sealing which only acts between the separator plates and the cathode gas-distributing plate and a sealing which acts between the cathode and separator plate.

22. Cell stack comprising a number of cell units according to claim 12, accommodated in a housing provided with a cathode gas supply manifold and a cathode gas discharge manifold.
